(19) United States
(12) Patent Application Publication
(10) Pub. No.: US 2017/0154601 A1
(43) Pub. Date: Jun. 1, 2017

(54) DISPLAY SUBSTRATE, DISPLAY DEVICE AND METHOD FOR DRIVING DISPLAY SUBSTRATE

(71) Applicants: Boe Technology Group Co., Ltd., Beijing (CN); Beijing Boe Optoelectronics Technology Co., Ltd., Beijing (CN)

(72) Inventors: Bo Gao, Beijing (CN); Xiurong Wang, Beijing (CN); Hao Zhang, Beijing (CN); Lingyun Shi, Beijing (CN); Xue Dong, Beijing (CN); Yafei Li, Beijing (CN); Peng Han, Beijing (CN)

(21) Appl. No.: 15/109,522

(22) PCT Filed: Jan. 15, 2016
(86) PCT No.: PCT/CN2016/071041

§ 371 Date: Jul. 1, 2016

(30) Foreign Application Priority Data
Jul. 20, 2015 (CN) 201510428891.5

(51) Int. Cl. G09G 5/00; G09G 3/20

(52) U.S. Cl. CPC G09G 5/003; G09G 3/2074; G09G 3/2003; G09G 2310/08; G09G 2330/021; G09G 2330/028; G09G 2310/0297

(57) ABSTRACT

The present disclosure relates to a display substrate and a driving method thereof as well as a display device. The display substrate includes: a plurality of pixels, each pixel including a plurality of sub-pixels; and a plurality of voltage control units, each voltage control unit being configured to selectively provide a same voltage or different voltages to the sub-pixels of respective ones of the plurality of pixels.

### CROSS-REFERENCE TO THE RELATED APPLICATIONS

The present application is the U.S. national phase entry of PCT/CN2016/071041, with an international filing date of Jan. 15, 2016, which claims the benefit of Chinese Patent Application No. 201510428891.5, filed on Jul. 20, 2015, the entire disclosures of which are incorporated herein by reference.

### TECHNICAL FIELD

The present disclosure relates to the field of display technology, and particularly to a display substrate, a display device and a method for driving the display substrate.

### BACKGROUND

Various problems have emerged with the development of the display technology and the increase of the user requirement, among which is the power consumption. For terminal devices such as mobile phones and pads which rely on batteries for operation, the limitation on the power consumption is more stringent.

### SUMMARY

It would be advantageous to provide a display substrate which may reduce the power consumption by simplifying generation/provision of a voltage for a pixel. It would also be advantageous to provide a display device comprising the display substrate and a method for driving the display substrate.

According to an aspect of the present disclosure, a display substrate is provided. The display substrate comprises: a plurality of pixels, each pixel comprising a plurality of sub-pixels; and a plurality of voltage control units, each voltage control unit configured to selectively provide a same voltage or different voltages to the sub-pixels of respective ones of the plurality of pixels.

In an embodiment, the display substrate may further comprise an information obtaining unit configured to obtain grayscale information of an image to be displayed, and an information adjusting unit configured to adjust the obtained grayscale information such that the adjusted grayscale information for the sub-pixels of the respective ones of the plurality of pixels is the same.

In an embodiment, the display substrate may further comprise a sensing unit configured to sense an operation performed on displayed content, and a timing unit configured to detect a duration in which the operation is not sensed by the sensing unit. Each of the plurality of voltage control units is configured to provide the same voltage to the sub-pixels of the respective ones of the plurality of pixels in response to the duration being greater than a first preset time period and less than a second preset time period.

In an embodiment, the voltage control unit may be configured to provide the different voltages to the sub-pixels of the respective ones of the plurality of pixels in response to the sensing unit sensing the operation performed on the displayed content.

In an embodiment, the display substrate may further comprise a recognizing unit configured to recognize a type of the displayed content. Each of the plurality of voltage control units is configured to provide the same voltage to the sub-pixels of the respective ones of the plurality of pixels in response to the displayed content being a static image and the duration being greater than a third preset time period and less than the second preset time period, and to provide the same voltage to the sub-pixels of the respective ones of the plurality of pixels in response to the displayed content being dynamic images and the duration being greater than a fourth preset time period and less than the second preset time period. The third preset time period is less than the fourth preset time period and greater than or equal to the first preset time period.

In an embodiment, the display substrate may further comprise a standby unit configured to control the display substrate to enter a standby mode in response to the duration being greater than or equal to the second preset time period.

In an embodiment, each of the plurality of voltage control units comprises a multiplexer comprising an input terminal for receiving voltages and a plurality of output terminals each for providing the received voltages to the sub-pixels for a same color in the respective ones of the plurality of pixels.

In an embodiment, each of the plurality of output terminals of the multiplexer may comprise a switch. Each of the plurality of voltage control units may be configured to cause its respective switches to simultaneously turn on so as to provide the same voltage received via the input terminal to the sub-pixels of the respective ones of the plurality of pixels. Each of the plurality of voltage control unit may be configured to cause its respective switches to turn on in a time division manner so as to provide the voltages received via the input terminal at different time intervals to the sub-pixels of the respective ones of the plurality of pixels respectively.

In an embodiment, the display substrate may further comprise a plurality of data lines, each data line being connected to a respective column of sub-pixels. The sub-pixels for the same color in each pixel are located in a same column, and data lines corresponding to the sub-pixels in each pixel are connected to respective output terminals of a respective multiplexer.

According to another aspect of the present disclosure, a display device is provided which comprises the display substrate as described above.

According to a further aspect of the present disclosure, a method for driving a display substrate is provided. The display substrate comprises a plurality of voltage control units and a plurality of pixels, each pixel comprising a plurality of sub-pixels. The method comprises providing selectively, by each of the plurality of voltage control units, a same voltage or different voltages to the sub-pixels of respective ones of the plurality of pixels.

In an embodiment, the method may further comprise prior to providing by each of the plurality of voltage control units the same voltage to the sub-pixels of the respective ones of the plurality of pixels: obtaining grayscale information of an image to be displayed; and adjusting the obtained grayscale information such that the adjusted grayscale information for the sub-pixels of the respective ones of the plurality of pixels is the same.

In an embodiment, providing selectively the same voltage or different voltages may comprise: sensing an operation performed on displayed content; detecting a duration in which the operation is not sensed; and providing by each of the plurality of voltage control units the same voltage to the sub-pixels of the respective ones of the plurality of pixels in response to the duration being greater than a first preset time period and less than a second preset time period.

In an embodiment, the method may further comprise: providing by each of the plurality of voltage control units the different voltages to the sub-pixels of the respective ones of the plurality of pixels in response to sensing the operation performed on the displayed content.

In an embodiment, the method may further comprise: recognizing a type of the displayed content; providing by each of the plurality of voltage control units the same voltage to the sub-pixels of the respective ones of the plurality of pixels in response to the displayed content being a static image and the duration being greater than a third preset time period and less than the second preset time period; and providing by each of the plurality of voltage control units the same voltage to the sub-pixels of the respective ones of the plurality of pixels in response to the displayed content being dynamic images and the duration being greater than a fourth preset time period and less than the second preset time period, the third preset time period being less than the fourth preset time period and greater than or equal to the first preset time period.

In an embodiment, the method may further comprise: controlling the display substrate to enter a standby mode in response to the duration being greater than or equal to the second preset time period.

According to embodiments of the present disclosure, enabling a pixel to display black-and-white tones (grayscales) by selectively providing a same voltage to the sub-pixels in the pixel may simplify generation/provision of a grayscale voltage, thereby saving power consumption.

### BRIEF DESCRIPTION OF THE DRAWINGS

The features and advantages of the present disclosure will be understood more clearly by referring to the drawings, which drawings are schematic and should not be construed as any limitations to the present disclosure. In the drawings:

FIG. 1 shows a schematic block diagram of a display substrate according to an embodiment of the present disclosure;

FIG. 2 shows a schematic view of a process of adjusting a color image to a black-and-white (grayscale) image;

FIG. 3 shows a schematic structural view of a display substrate according to an embodiment of the present disclosure;

FIG. 4 shows a schematic view of a set of example control signals for controlling output terminals in a voltage control unit;

FIG. 5 shows a schematic view of another set of example control signals for controlling output terminals in a voltage control unit; and

FIGS. 6A and 6B show schematic flow charts of a method for driving a display substrate according to an embodiment of the present disclosure.

### DETAILED DESCRIPTION

For a better understanding of the purposes, features and advantages of the present disclosure, embodiments of the present disclosure will be described in more detail below with reference to the drawings. It should be noted that the embodiments or the features thereof may be combined with one another without conflicting.

While many specific details are elaborated in the following for a full understanding of the present disclosure, the present disclosure may be implemented using other schemes than those described herein. Hence, the protection scope of the present disclosure is not limited by the specific embodiments disclosed below.

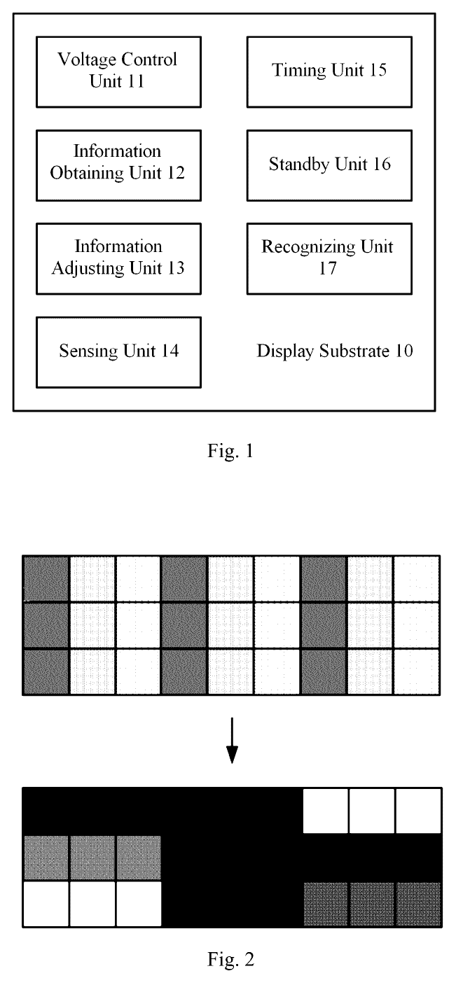

FIG. 1 shows a schematic block diagram of a display substrate 10 according to an embodiment of the present disclosure. As known, the display substrate 10 may comprise a plurality of pixels (not shown), each pixel comprising a plurality of sub-pixels. The display substrate 10 further comprises a plurality of voltage control units 11, each voltage control unit configured to selectively provide a same voltage or different voltages to the sub-pixels of respective ones of the plurality of pixels.

The pixel is enabled to display color tones by providing different grayscale voltages to its different sub-pixels, and is enabled to display black-and-white tones (grayscales) by providing a same grayscale voltage to its different sub-pixels. Where no color display is required, for example when the user is reading a text, black-and-white display may be realized by providing the same voltage to different sub-pixels of the pixel through the voltage control unit 11. In this case, it is not required to generate different grayscale voltages for different sub-pixels. Thus, the generation of the voltage is simplified. For instance, only one digital-to-analog converter needs to operate in a source driver chip to generate a grayscale voltage for individual sub-pixels of one pixel, without requiring as many digital-to-analog converters as the sub-pixels. This may save the power consumption, particularly for mobile terminals such as mobile phones and pads which are powered by batteries.

To provide the same grayscale voltage to individual sub-pixels of one pixel, the grayscale information for the sub-pixels may be firstly converted into a same value. As shown in FIG. 1, the display substrate 10 further comprises an information obtaining unit 12 configured to obtain grayscale information of an image to be displayed and an information adjusting unit 13 configured to adjust the obtained grayscale information. The information adjusting unit 13 may adjust the obtained grayscale information such that the adjusted grayscale values for the sub-pixels in the pixel are the same. The grayscale value may be converted into a grayscale voltage for example by a digital-to-analog converter in a source driver chip, and the grayscale voltage is then provided to corresponding sub-pixels by the voltage control unit 11.

FIG. 2 schematically shows a process of adjusting a color image to a black-and-white (grayscale) image. In FIG. 2, the upper image is a color image before the adjustment (wherein color information is not shown), and the lower image is a black-and-white (grayscale) image derived as a result of the adjustment. The information adjusting unit 13 may adjust the grayscale information based on a preset algorithm. In one example, the average of the grayscale values of the sub-pixels of one pixel may be taken as the adjusted grayscale value of the sub-pixels. Of course, other adjustment schemes are possible.

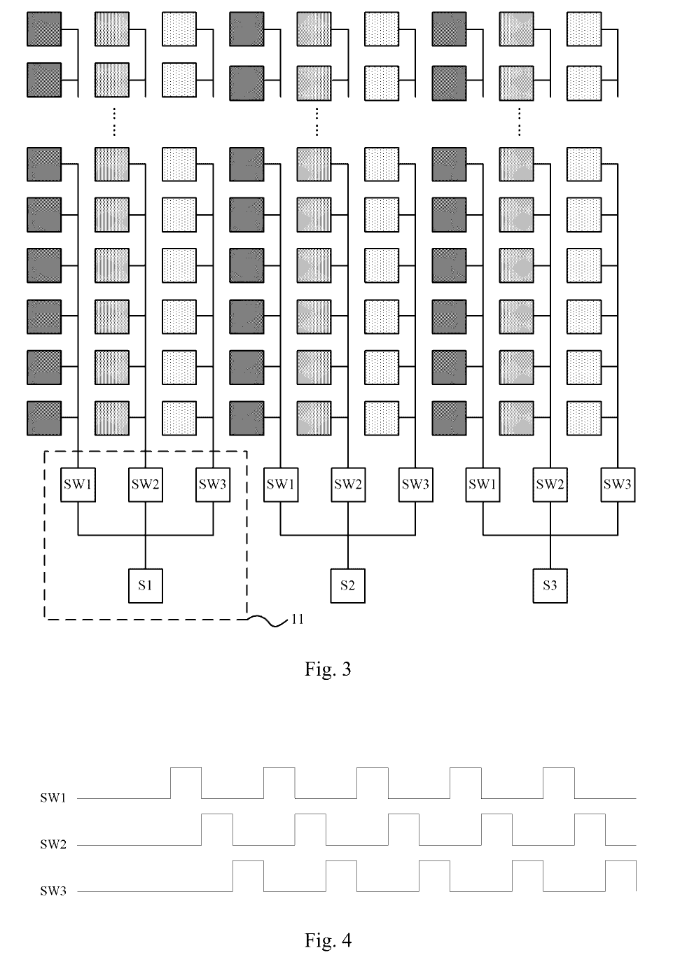

FIG. 3 shows a schematic structure of a display substrate according to an embodiment of the present disclosure. As shown in FIG. 3, each pixel comprises three sub-pixels each for red, green and blue respectively, which sub-pixels are represented by different shaded blocks. In this example, the voltage control unit 11 comprises a multiplexer (“MUX”). The multiplexer comprises an input terminal Sx (x=1, 2, 3 . . . ) for receiving voltages and output terminals SW1, SW2, SW3 for providing the received voltages to the sub-pixels for the same color.

The display substrate may further comprise a plurality of data lines, each data line being connected to a respective column of sub-pixels. In this example, the sub-pixels for the same color are located in a same column, and data lines corresponding to respective sub-pixels of one pixel are connected to respective output terminals of one multiplexer.

Each column of pixels correspond to a respective one of the input terminals Sx (x=1, 2, 3 . . . ), wherein the first column of pixels correspond to input terminal S1, the second column of pixels correspond to input terminal S2, the third column of pixels correspond to input terminal S3, and so forth. Each column of sub-pixels correspond to a respective one of the output terminals, wherein the first column of sub-pixels (e.g. the red sub-pixels) correspond to output terminal SW1, the second column of sub-pixels (e.g. the green sub-pixels) correspond to output terminal SW2, and the third column of sub-pixels (e.g. the blue sub-pixels) correspond to output terminal SW3. In this example, each of the output terminals SW1, SW2, SW3 of the multiplexer comprises a switch. Such a multiplexer has a simple structure and may simplify the wiring in the substrate.

The voltage control unit 11 may be configured to cause its respective switches to turn on in a time division manner so as to provide voltages received by the input terminal at different time intervals to the sub-pixels of a plurality of pixels respectively. As shown in FIG. 4, the control signals applied to the switches of the output terminals SW1, SW2, SW3 are active high, i.e., a high level instructs the switch to turn on, and a low level instructs the switch to turn off. Under the control of such control signals, the switches in the output terminals SW1, SW2, SW3 successively turn on/off such that the grayscale voltages received by the input terminal at different time intervals are provided to different sub-pixels of a plurality of pixels respectively. In this way, with the cooperation of a gate scan pulse signal, the voltage control unit 11 may provide different grayscale voltages to different sub-pixels of one pixel, thereby realizing color display.

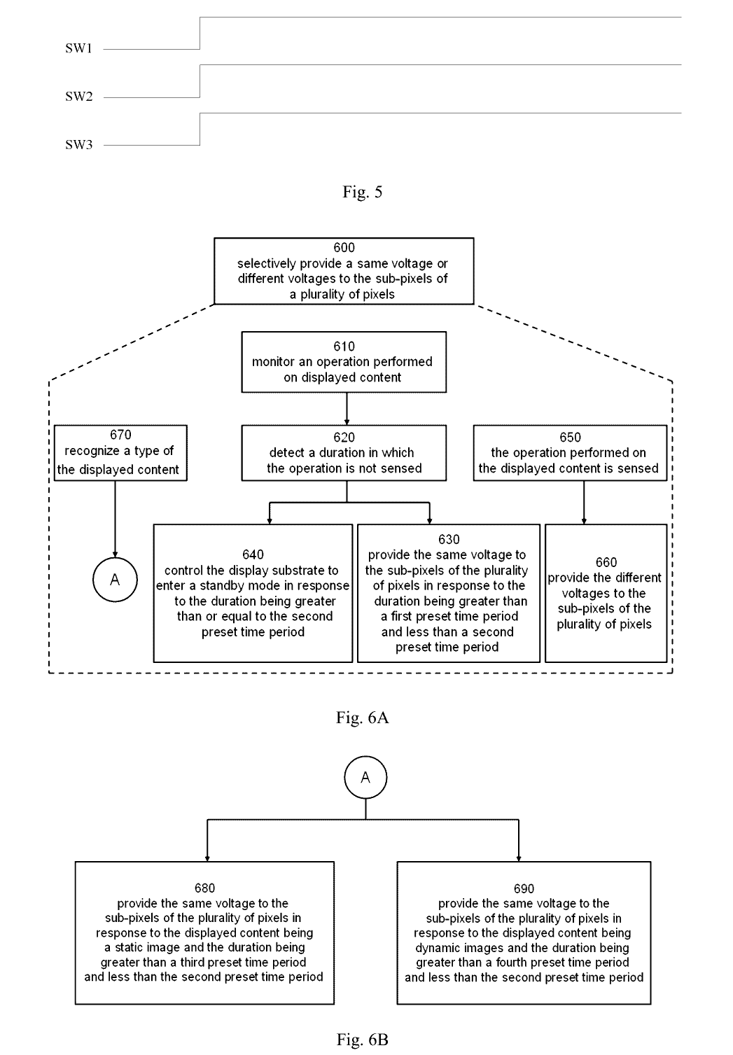

The voltage control unit 11 may be further configured to cause its respective switches to simultaneously turn on so as to provide a same voltage received by the input terminal to the sub-pixels of a plurality of pixels. As shown in FIG. 5, the control signals applied to the switches of the output terminals SW1, SW2, SW3 are active high, i.e., a high level instructs the switch to turn on, and a low level instructs the switch to turn off. Under the control of such control signals, the switches in the output terminals SW1, SW2, SW3 simultaneously turn on such that the same voltage received by the input terminal is provided to the sub-pixels of a plurality of pixels. In this way, with the cooperation of a gate scan pulse signal, the voltage control unit 11 may provide the same grayscale voltage to different sub-pixels of one pixel, thereby realizing black-and-white (grayscale) display.

It should be noted that although the pixel in FIG. 3 is shown as comprising three kinds of sub-pixels—red, green, and blue, other embodiments are possible. For instance, the pixel may also comprise four kinds of sub-pixels—red, green, blue, and white. The specific structure of the voltage control unit 11 may be adapted in dependence on the configuration of the pixel. Specifically, the number of the output terminals of the multiplexer may be set based on the number of the sub-pixels in one pixel. For example, if one pixel comprises three kinds of sub-pixels—red, green, and blue, then one multiplexer may be provided with three output terminals. If one pixel comprises four kinds of sub-pixels—red, green, blue, and white, then one multiplexer may be provided with four output terminals.

Referring back to FIG. 1, the display substrate 10 further comprises a sensing unit 14 configured to sense an operation performed on displayed content and a timing unit 15 configured to detect a duration in which the operation is not sensed by the sensing unit 14.

The voltage control unit 11 may be configured to provide a same voltage to the sub-pixels of a plurality of pixels in response to the duration being greater than a first preset time period and less than a second preset time period. In this way, when no operation is performed on the displayed content within a relatively short time (i.e., within the first preset time period), the display substrate may enter a black-and-white display mode so as to, for example, reduce the power consumption. The voltage control unit 11 may be further configured to (e.g., in any case) provide different voltages to the sub-pixels of the plurality of pixels in response to the sensing unit 14 sensing an operation performed on the displayed content. This enables the displayed content in a black-and-white display mode to be displayed with color tones once a user performs an operation to the displayed content, thereby improving the user experience.

In some embodiments, the display substrate 10 may further comprise a standby unit 16 that is configured to control the display substrate 10 to enter a standby mode in response to the duration being greater than or equal to the second preset time period. In other words, when no operation is performed on the displayed content within a relatively long time (i.e., within the second preset time period), the display substrate may be controlled to enter the standby mode to further reduce the power consumption.

In some embodiments, the display substrate 10 may further comprise a recognizing unit 17 that is configured to recognize a type of displayed content. The voltage control unit 11 may be configured to provide a same voltage to the sub-pixels of a plurality of pixels in response to the displayed content being a static image and the duration being greater than a third preset time period and less than the second preset time period. The voltage control unit 11 may be further configured to provide a same voltage to the sub-pixels of the plurality of pixels in response to the displayed content being dynamic images and the duration being greater than a fourth preset time period and less than the second preset time period. The third preset time period is less than the fourth preset time period and greater than or equal to the first preset time period.

This is based on the considerations that (i) the time interval between operations by a user tends to be relatively short when he or she is viewing a static image such as a picture or a novel, and that (ii) the time interval between operations by the user tends to be relatively long when he or she is viewing dynamic images such as a movie. Therefore, where the displayed content is a static image, the displayed content may be adjusted to a black-and-white image if the user does not perform operations to the displayed content within a relatively short time period (i.e., within the third preset time period). Where the displayed content are dynamic images, in order to prevent the images from becoming black-and-white when viewed by the user, the displayed content may be adjusted to black-and-white images only if the user does not perform operations to the displayed content within a relatively long time (i.e., within the fourth preset time period). In this way, a more intelligent transition of the images can be achieved while reducing the power consumption. This improves the user experience.

According to another aspect of the present disclosure, a display device is further provided which comprises the display substrate 10 as described above. In embodiments, the display device may be any product or component with a display function such as an E-ink display, a mobile phone, a pad, a television, a laptop, a digital photo frame, or a navigator.

FIGS. 6A and 6B show schematic flow charts of a method 600 for driving a display substrate according to an embodiment of the present disclosure. The method 600 may be used for driving the display substrate 10 as described above.

Generally, the method 600 comprises selectively providing a same voltage or different voltages to the sub-pixels of a plurality of pixels. This may be done by the voltage control unit 11 as described above. In particular, prior to providing the same voltage to the sub-pixels of the plurality of pixels, the grayscale information of an image to be displayed may be obtained, and the obtained grayscale information is adjusted such that the adjusted grayscale information for the sub-pixels of respective ones of the plurality of pixels is the same. As stated above, the grayscale information may be converted into a grayscale voltage for example by a digital analog converter in a source driver chip, and the grayscale voltage is then provided to corresponding sub-pixels by the voltage control unit 11.

Specifically, at step 610, an operation performed on the displayed content is monitored. At step 620, a duration in which the operation is not sensed is detected. At step 630, the same voltage is provided to the sub-pixels of the plurality of pixels in response to the duration being greater than a first preset time period and less than a second preset time period. At step 640, the display substrate 10 is controlled to enter a standby mode in response to the duration being greater than or equal to the second preset time period.

In some embodiments, at step 650, the operation performed on the displayed content is sensed. At step 660, the different voltages are provided to the sub-pixels of the plurality of pixels.

In some embodiments, at step 670, a type of the displayed content is recognized. At step 680, the same voltage is provided to the sub-pixels of the plurality of pixels in response to the displayed content being a static image and the duration being greater than a third preset time period and less than the second preset time period. At step 690, the same voltage is provided to the sub-pixels of the plurality of pixels in response to the displayed content being dynamic images and the duration being greater than a fourth preset time period and less than the second preset time period. As stated above, the third preset time period is less than the fourth preset time period and greater than or equal to the first preset time period.

It should be noted that the “pixel” mentioned above refers to a pixel comprising a plurality of sub-pixels, rather than to a sub-pixel. In addition, the terms “first”, “second”, “third” and “fourth” as used herein are only for purposes of description and should not be construed as indicating or implying relative significance. Unless otherwise specified, the term “a plurality of” refers to two or more than two.

The foregoing are only specific embodiments of the present disclosure, and are not for limiting the present disclosure. Various modifications and variations to the present disclosure may be made by the skilled person in the art. Any modifications, equivalent replacements, or improvements that are made within the spirit and the principle of the present disclosure should be encompassed within the protection scope of the present disclosure.

1. A display substrate, comprising:
a plurality of pixels, each pixel comprising a plurality of sub-pixels; and
a plurality of voltage control units, each voltage control unit configured to selectively provide a same voltage or different voltages to the sub-pixels of a respective one of the plurality of pixels.

2. The display substrate according to claim 1, further comprising:
an information obtaining unit configured to obtain grayscale information of an image to be displayed; and
an information adjusting unit configured to adjust the obtained grayscale information such that the adjusted grayscale information for the sub-pixels of the respective one of the plurality of pixels is the same.

3. The display substrate according to claim 1, further comprising:
a sensing unit configured to sense an operation performed on displayed content; and
a timing unit configured to detect a duration in which the operation is not sensed by the sensing unit,
wherein each of the plurality of voltage control units is configured to provide the same voltage to the sub-pixels of the respective one of the plurality of pixels in response to the duration being greater than a first preset time period and less than a second preset time period.

4. The display substrate according to claim 3, wherein the voltage control unit is configured to provide the different voltages to the sub-pixels of the respective one of the plurality of pixels in response to the sensing unit sensing the operation performed on the displayed content.

5. The display substrate according to claim 3, further comprising:
a recognizing unit configured to recognize a type of the displayed content,
wherein each of the plurality of voltage control units is configured to provide the same voltage to the sub-pixels of the respective one of the plurality of pixels in response to the displayed content being a static image and the duration being greater than a third preset time period and less than the second preset time period, and to provide the same voltage to the sub-pixels of the respective one of the plurality of pixels in response to the displayed content being dynamic images and the duration being greater than a fourth preset time period and less than the second preset time period, the third preset time period being less than the fourth preset time period and greater than or equal to the first preset time period.

6. The display substrate according to claim 3, further comprising:
a standby unit configured to control the display substrate to enter a standby mode in response to the duration being greater than or equal to the second preset time period.

7. The display substrate according to claim 1, wherein each of the plurality of voltage control units comprises a multiplexer comprising an input terminal for receiving voltages and a plurality of output terminals for providing the received voltages to respective sub-pixels in the respective one of the plurality of pixels.

8. The display substrate according to claim 7, wherein each of the plurality of output terminals of the multiplexer comprises a switch, and wherein each of the plurality of voltage control units is configured to provide the same voltage received via the input terminal to the sub-pixels of the respective one of the plurality of pixels by causing its respective switches to simultaneously turn on, and to provide the voltages received via the input terminal at different time intervals to the sub-pixels of the respective one of the plurality of pixels respectively by causing its respective switches to turn on in a time division manner.

9. The display substrate according to claim 7, further comprising a plurality of data lines, each data line connecting a respective column of sub-pixels to a respective one of the output terminals of the multiplexers, wherein the respective column of sub-pixels are for a same color.

10. A display device comprising the display substrate according to claim 1.

11. A method for driving a display substrate, the display substrate comprising a plurality of voltage control units and a plurality of pixels, each pixel comprising a plurality of sub-pixels, the method comprising:
providing selectively, by each of the plurality of voltage control units, a same voltage or different voltages to the sub-pixels of a respective one of the plurality of pixels.

12. The method according to claim 11, wherein the method further comprises prior to providing by each of the plurality of voltage control units the same voltage to the sub-pixels of the respective one of the plurality of pixels:
obtaining grayscale information of an image to be displayed; and
adjusting the obtained grayscale information such that the adjusted grayscale information for the sub-pixels of the respective one of the plurality of pixels is the same.

13. The method according to claim 11, wherein providing selectively the same voltage or different voltages comprises:
sensing an operation performed on displayed content;
detecting a duration in which the operation is not sensed; and
providing by each of the plurality of voltage control units the same voltage to the sub-pixels of the respective one of the plurality of pixels in response to the duration being greater than a first preset time period and less than a second preset time period.

14. The method according to claim 13, further comprising:
providing by each of the plurality of voltage control units the different voltages to the sub-pixels of the respective one of the plurality of pixels in response to sensing the operation performed on the displayed content.

15. The method according to claim 13, further comprising:
recognizing a type of the displayed content;
providing by each of the plurality of voltage control units the same voltage to the sub-pixels of the respective one of the plurality of pixels in response to the displayed content being a static image and the duration being greater than a third preset time period and less than the second preset time period; and
providing by each of the plurality of voltage control units the same voltage to the sub-pixels of the respective one of the plurality of pixels in response to the displayed content being dynamic images and the duration being greater than a fourth preset time period and less than the second preset time period, the third preset time period being less than the fourth preset time period and greater than or equal to the first preset time period.

16. The method according to claim 13, further comprising: controlling the display substrate to enter a standby mode in response to the duration being greater than or equal to the second preset time period.
